(19) United States
(12) Patent Application Publication
(10) Pub. No.: US 2023/0000083 A1
(43) Pub. Date: Jan. 5, 2023

(54) ANTIBACTERIAL AND ANTIFUNGAL POLYESTER LAMINATED STRUCTURE

(71) Applicant: NAN YA PLASTICS CORPORATION, Taipei (TW)

(72) Inventors: TE-CHAO LIAO, TAIPEI (TW); CHUN-CHE TSAO, TAIPEI (TW); Yueh-Shin Liu, Taipei City (TW)

(21) Appl. No.: 17/534,364

(22) Filed: Nov. 23, 2021

(30) Foreign Application Priority Data
Jun. 30, 2021 (TW) 110123917

(51) Int. Cl. A01N 59/16; A01N 25/10; A01N 25/22; A01P 1/00

(52) U.S. Cl. CPC A01N 59/16; A01N 25/10; A01N 25/22; A01P 1/00

(57) ABSTRACT

An antibacterial and antifungal polyester laminated structure is provided, and includes a main structure support layer and an antibacterial and antifungal functional layer. The main structure support layer is formed of a polyester material, and the main structure support layer enables the polyester laminated structure to have an impact-resistant strength of not less than 20 kg-cm/cm. The antibacterial and antifungal functional layer is formed of an antibacterial and antifungal polyester material, and the antibacterial and antifungal polyester material includes an antibacterial and antifungal additive. The antibacterial and antifungal additive includes a plurality of glass beads that are dispersed in the antibacterial and antifungal functional layer. A plurality of silver nanoparticles are distributed on an outer surface of each of the glass beads, and the antibacterial and antifungal additive enables the antibacterial and antifungal functional layer to have antibacterial and antifungal capabilities.

### CROSS-REFERENCE TO RELATED PATENT APPLICATION

This application claims the benefit of priority to Taiwan Patent Application No. 110123917, filed on Jun. 30, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a laminated structure, and more particularly to an antibacterial and antifungal polyester laminated structure.

### BACKGROUND OF THE DISCLOSURE

Based on market demands, products such as luggage cases, food trays, and freezer trays have begun to require antibacterial and antifungal capabilities. To enable a surface of a material to have antibacterial and antifungal capabilities, most of conventional technologies are implemented by using a coating method or a spraying method. Although the use of these methods can enable the surface of the material to have antibacterial and antifungal capabilities, the antibacterial and antifungal effect on the surface of these materials cannot be maintained for a desired period of time. Furthermore, the types of bacteria correspondingly affected by the antibacterial and antifungal effect on the surface of these materials are limited.

In addition, the conventional technologies also use a sheet material (i.e., ABS, PC, PP and other sheets) that has a film material having antibacterial and antifungal capabilities attached thereon. However, the use of attaching methods such as adhesion will result in a high material cost, and since the laminated structure is not composed of a single material, inconveniences when recycling materials of the laminated structure can be caused.

### SUMMARY OF THE DISCLOSURE

In response to the above-referenced technical inadequacies, the present disclosure provides an antibacterial and antifungal polyester laminated structure.

In one aspect, the present disclosure provides an antibacterial and antifungal polyester laminated structure, including: a main structure support layer and two antibacterial and antifungal functional layers. The main structure support layer has two side surfaces opposite to each other. The main structure support layer is formed of an impact-resistant polyester material, and the main structure support layer enables the polyester laminated structure to have an impact-resistant strength of not less than 20 kg-cm/cm. The two antibacterial and antifungal functional layers are respectively formed on the two side surfaces of the main structure support layer. Each of the antibacterial and antifungal functional layers is formed of an antibacterial and antifungal polyester material, the antibacterial and antifungal polyester material includes an antibacterial and antifungal additive, and the antibacterial and antifungal additive includes a plurality of glass beads. The plurality of glass beads are dispersed in the antibacterial and antifungal functional layers, a plurality of silver nanoparticles are distributed on an outer surface of each of the glass beads, and the antibacterial and antifungal additive enables each of the antibacterial and antifungal functional layers to have antibacterial and antifungal capabilities.

In certain embodiments, the main structure support layer and the two antibacterial and antifungal functional layers are formed into an antibacterial and antifungal polyester sheet material with a sandwich structure by co-extrusion. A thickness of the main structure support layer is greater than a thickness of each of the antibacterial and antifungal functional layers, the thickness of the main structure support layer is between 80 μm and 4,000 μm, and the thickness of each of the antibacterial and antifungal functional layers is between 10 μm and 200 μm.

In certain embodiments, in the main structure support layer, the impact-resistant polyester material includes: a polyester resin matrix material, a toughening agent, and a compatibilizing agent. The toughening agent is dispersed in the polyester resin matrix material; in which the toughening agent is a polyolefin elastomer (POE). The compatibilizing agent is dispersed in the polyester resin matrix material; in which the compatibilizing agent is configured to assist in improving a compatibility between the toughening agent and the polyester resin matrix material. The compatibilizing agent is configured to assist the toughening agent to be dispersed into the polyester resin matrix material with a particle size between 0.5 μm and 1.5 μm, so that the impact-resistant polyester material has the impact-resistant strength of not less than 20 kg-cm/cm.

In certain embodiments, in the main structure support layer, the compatibilizing agent is at least one of a polyolefin elastomer grafted with glycidyl methacrylate (POE-g-GMA) and a polyolefin elastomer grafted with maleic anhydride (POE-g-MAH).

In certain embodiments, based on a total weight of the impact-resistant polyester material being 100 wt %, a content of the polyester resin matrix material is between 70 wt % to 95 wt %, a content of the toughening agent is between 5 wt % and 15 wt %, and a content of the compatibilizing agent is between 2 wt % and 15 wt %. The content of the toughening agent is not less than the content of the compatibilizing agent, and a weight ratio of the toughening agent relative to the compatibilizing agent ranges from 1:1 to 4:1.

In certain embodiments, a molecular structure of the toughening agent is all polyolefin elastomer (POE), the compatibilizing agent is a polyolefin elastomer grafted with glycidyl methacrylate (POE-g-GMA), a molecular structure of the compatibilizing agent has a main chain and a side chain melt-grafted with the main chain, the main chain is the polyolefin elastomer (POE), and the side chain is the glycidyl methacrylate (GMA). The glycidyl methacrylate can produce a ring-opening reaction during a mixing process, and an epoxy group in the glycidyl methacrylate can chemically react with an ester group in a molecular structure of the polyester resin matrix material after the ring-opening reaction.

In certain embodiments, in each of the antibacterial and antifungal functional layers, the antibacterial and antifungal polyester material further includes: a polyester resin substrate material and a plurality of functional polyester masterbatches. The plurality of functional polyester masterbatches are dispersed in the polyester resin substrate material by means of melt extrusion molding. Each of the functional polyester masterbatches includes a polyester resin matrix and the antibacterial and antifungal additive, and the plurality of glass beads of the antibacterial and antifungal additive are dispersed in the polyester resin matrix.

In certain embodiments, based on a total weight of the antibacterial and antifungal polyester material being 100 wt %, a content of the polyester resin substrate material is between 80 wt % and 98 wt %, and a content of the plurality of functional polyester masterbatches is between 2 wt % and 20 wt %. In each of the functional polyester masterbatches, a weight ratio of the polyester resin matrix relative to the antibacterial and antifungal additive ranges from 70 to 99: 1 to 30.

In certain embodiments, the antibacterial and antifungal polyester laminated structure is capable of being formed into an extended polyester material through an extension molding process. In each of the antibacterial and antifungal functional layers, at least part of the plurality of glass beads are distributed on a surface portion of the antibacterial and antifungal functional layer, so that at least part of the plurality of silver nanoparticles are exposed to an outside environment, and accordingly the antibacterial and antifungal functional layer can have antibacterial and antifungal capabilities.

In certain embodiments, the polyester resin substrate material is polyethylene terephthalate, and in each of the functional polyester masterbatches, the polyester resin matrix is polyethylene terephthalate. The polyester resin substrate material has a first refractive index, the polyester resin matrix has a second refractive index, and each of the glass beads has a third refractive index. The first refractive index is between 1.55 and 1.60, the second refractive index is between 95% and 105% of the first refractive index, and the third refractive index is between 95% and 105% of the first refractive index.

In certain embodiments, in each of the glass beads, a matrix material of the glass bead is soluble glass powders, a particle size of the glass bead is not greater than 10 μm, a density of the glass bead is between 2 g/cm³ and 3 g/cm³, and a heat-resistant temperature of the glass beads is not less than 500° C.

In certain embodiments, in each of the glass beads, the antibacterial and antifungal additive has an antibacterial ability against the following types of bacteria, including: Escherichia coli, Staphylococcus aureus, Pneumoniae bacillus, Salmonella, Pseudomonas aeruginosa, and drug-resistant Staphylococcus aureus. The antibacterial and antifungal additive has an antifungal ability against the following types of fungus, including: Aspergillus niger, Penicillium tetrapine, Chaetomium globosum, Gliocladium virens, and Aureobasidium pullulans.

In certain embodiments, a matrix material of the main structure support layer is polyethylene terephthalate, and a matrix material of each of the antibacterial and antifungal functional layers is polyethylene terephthalate.

In another aspect, the present disclosure provides an antibacterial and antifungal polyester laminated structure that includes a main structure support layer and an antibacterial and antifungal functional layer. The main structure support layer has two side surfaces opposite to each other. The main structure support layer is formed of an impact-resistant polyester material, and the main structure support layer enables the polyester laminated structure to have an impact-resistant strength of not less than 20 kg-cm/cm. The antibacterial and antifungal functional layer is formed on one of the two side surfaces of the main structure support layer. The antibacterial and antifungal functional layer is formed of an antibacterial and antifungal polyester material, the antibacterial and antifungal polyester material includes an antibacterial and antifungal additive, and the antibacterial and antifungal additive includes a plurality of glass beads. The plurality of glass beads are dispersed in the antibacterial and antifungal functional layer, a plurality of silver nanoparticles are distributed on an outer surface of each of the glass beads, and the antibacterial and antifungal additive enables the antibacterial and antifungal functional layer to have antibacterial and antifungal capabilities.

Therefore, the antibacterial and antifungal polyester laminated structure of the present disclosure can be applied to products with requirements for antibacterial, antifungal and impact resistance capabilities, such as luggage cases, food trays, and freezer trays, and so on, by virtue of “the surface layer of the polyester laminated structure being an antibacterial and antifungal functional layer with antibacterial and antifungal capabilities, and the inner layer of the polyester laminated structure being a main structure support layer with supporting ability” and “the main structure support layer being formed of an impact-resistant polyester material, and the main structure support layer enabling an entirety of the polyester laminated structure to have an impact-resistant strength of not less than 20 kg-cm/cm” and “each of the antibacterial and antifungal functional layers being formed of an antibacterial and antifungal polyester material, and the antibacterial and antifungal polyester material enabling the surface layer of the polyester laminated structure to have the capabilities of antibacterial and antifungal”.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an antibacterial and antifungal polyester laminated structure according to a first embodiment of the present disclosure;

FIG. 2 is a partial enlarged view of region II in FIG. 1;

FIG. 3 is a partial enlarged view of region III in FIG. 1; and

FIG. 4 is a schematic view of an antibacterial and antifungal polyester laminated structure according to a second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

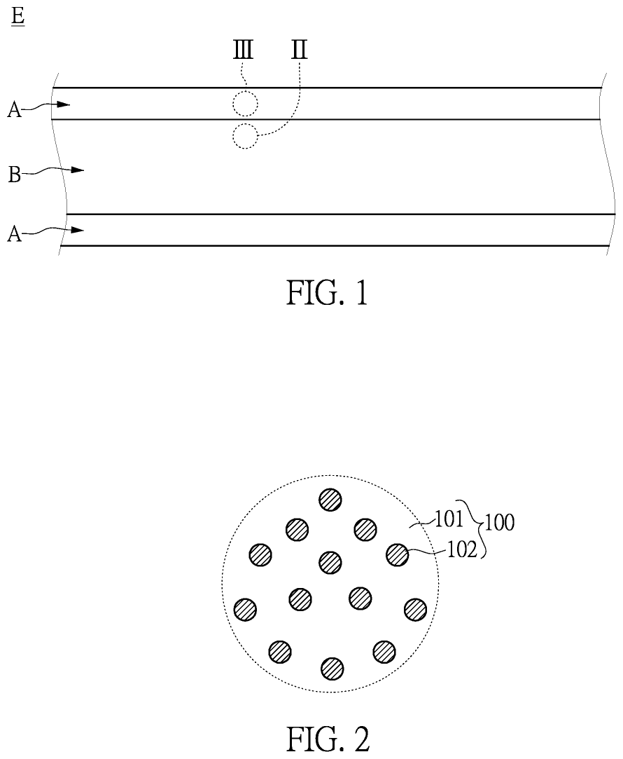

Referring to FIG. 1 to FIG. 3, a first embodiment of the present disclosure provides an antibacterial and antifungal polyester laminated structure E. The antibacterial and antifungal polyester laminate structure E can be, for example, a sandwich structure (A-B-A) formed by a co-extrusion process.

One of the objectives of the present disclosure is that two surface layers of the sandwich structure are both antibacterial and antifungal functional layers A having antibacterial and antifungal capabilities, and a middle layer of the sandwich structure is a main structure support layer B having a supporting capability. Furthermore, the antibacterial and antifungal polyester laminated structure E can be directly applied, or can be formed into an extended polyester sheet material through a vacuum forming process or a blister molding process.

One of the objectives of the present disclosure is that a matrix material of each layer of the antibacterial and antifungal polyester laminated structure E is a polyester material, such as PET. That is, the matrix materials of all layers of the antibacterial and antifungal polyester laminated structure E are the same material. Accordingly, the antibacterial and antifungal polyester laminated structure E can be easily recycled and discarded. In addition, the antibacterial and antifungal polyester laminated structure E has antibacterial and antifungal capabilities, and has high impact resistance. Therefore, the antibacterial and antifungal polyester laminated structure E can be applied to products with requirements of antibacterial, antifungal and impact resistance. For example, the antibacterial and antifungal polyester laminated structure E can be applied to the products such as luggage, food plate, freezer plate, and so on.

Reference is further made to FIG. 1 to FIG. 3, more specifically, the antibacterial and antifungal polyester laminated structure E includes a main structure support layer B and two antibacterial and antifungal functional layers A. The main structure support layer B has two side surfaces opposite to each other (not labeled in the drawings), and the two antibacterial and antifungal functional layers A are respectively formed on the two side surfaces of the main structure support layer B.

The main structure support layer B is formed of an impact-resistant polyester material 100, and the main structure support layer B enables an entirety of the polyester laminated structure to have an impact-resistant strength of not less than 20 kg-cm/cm. In addition, each of the antibacterial and antifungal functional layers A is formed of an antibacterial and antifungal polyester material 200, and the antibacterial and antifungal polyester material 200 enables the two surface layers of the polyester laminated structure E to have antibacterial and antifungal capabilities.

In terms of thickness range, a thickness of the main structure support layer B is greater than a thickness of each of the antibacterial and antifungal functional layers A, the thickness of the main structure support layer B is between 80 μm and 4000 μm, and the thickness of each of the antibacterial and antifungal functional layers A is between 10 μm and 200 μm. From another perspective, the thickness of the main structure support layer B is between 2 times to 400 times the thickness of each of the antibacterial and antifungal functional layers A, but the present disclosure is not limited thereto. Material characteristics of the impact-resistant polyester material 100 of the main structure support layer B and material characteristics of the antibacterial and antifungal polyester material 200 of the antibacterial and antifungal functional layer A will be described in detail as follows.

### Impact-Resistant Polyester Material

Referring to FIG. 2, the impact-resistant polyester material 100 of the main structure support layer B includes a polyester resin matrix material 101, a toughening agent 102 (or impact-resistant modifier), and a compatibilizing agent (not labeled in the drawings).

One of the objectives of the present disclosure is to improve the compatibility between the toughening agent 102 and the polyester resin matrix material 101 and to improve the dispersibility of the toughening agent 102 in the polyester resin matrix material 101. Therefore, the impact-resistant polyester material 100 of the present embodiment can have relatively high impact-resistant strength. For example, an impact-resistant strength of a general polyester material is not greater than 5 kg-cm/cm. On the other hand, an impact-resistant strength of the impact-resistant polyester material 100 of the present embodiment can be greatly increased to not less than 20 kg-cm/cm, and preferably between 28 kg-cm/cm and 50 kg-cm/cm.

In the present embodiment, the polyester resin matrix material 101 is the matrix material of the impact-resistant polyester material 100. The polyester resin matrix material 101 is a high molecular weight polymer obtained by a condensation polymerization reaction of a dibasic acid and a diol or its derivatives. In other words, the polyester resin matrix material 101 is a polyester material. Preferably, the polyester material is polyethylene terephthalate (PET), but the present disclosure is not limited thereto.

In terms of content, based on a total weight of the impact-resistant polyester material 100, a content of the polyester resin matrix material 101 is preferably between 70 wt % and 95 wt %, and more preferably between 70 wt % and 90 wt %. It should be noted that the term “substrate material” or “matrix material” as used herein refers to a material whose content occupies at least half of a composition.

Referring to FIG. 2 again, in order to enable the impact-resistant polyester material 100 to have a high impact resistance, the toughening agent 102 (also known as impact-resistant modifier) is added into the impact-resistant polyester material 100, and the toughening agent 102 is dispersed in the polyester resin matrix material 101. In terms of material types, the toughening agent is polyolefin elastomer (POE), which is also known as polyolefin thermoplastic elastomer. The toughening agent 102 dispersed in the polyester resin matrix material 101 can be used to improve the impact-resistant strength of the impact-resistant polyester material 100.

In terms of content, based on the total weight of the impact-resistant polyester material 100, a content of the toughening agent 102 is preferably between 5 wt % and 15 wt %, and more preferably between 7 wt % and 10 wt %.

According to the above-mentioned configuration, the impact-resistant polyester material 100 can have high impact resistance through the addition of the toughening agent 102. If the content of the toughening agent 102 is less than the lower limit of the above-mentioned content, the impact-resistant polyester material 100 will not have sufficient impact-resistant strength and cannot be applied to the products that require high impact resistance. Conversely, if the content of the toughening agent 102 is greater than the upper limit of the above-mentioned content, the toughening agent 102 will not be uniformly dispersed in the polyester resin matrix material 101, such that aggregation or precipitation of the toughening agent 102 occurs in the polyester resin matrix material 101, thereby affecting a formation of a final product, and affecting a performance of the impact-resistant strength.

From another perspective, one of the objectives of the present disclosure is to improve the impact-resistant strength of polyester materials, so that the polyester materials can have high impact-resistant strength, high rigidity, and low material cost at the same time. In order to achieve the foregoing objective, the impact-resistant polyester material 100 of the present embodiment uses polyolefin elastomer (POE) as a toughening agent (also known as impact-resistant modifier).

Compared with acrylic elastomer or polyester elastomer, the polyolefin elastomer (POE) has a better intrinsic toughness and a lower material price.

Therefore, adopting the polyolefin elastomer to improve the impact-resistant strength of the polyester materials has considerable advantages. However, the compatibility between the polyolefin elastomer and the polyester material is poor. When only the polyolefin elastomer is directly mixed with the polyester material by an additive modification method, the polyolefin elastomer is easy to agglomerate, and the impact-resistant strength of the polyester material cannot be significantly improved.

Accordingly, one of the features of the present disclosure is to adjust a dispersed particle size of the polyolefin elastomer in the polyester material to be between 0.5 μm and 1.5 μm, and preferably between 0.5 μm and 1.2 μm by virtue of the compatibility modification, viscosity matching, and kneading dispersion technology between the polyolefin elastomer and the polyester material. Within the dispersed particle size, the impact-resistant polyester material 100 of the present embodiment can achieve high impact resistance characteristics.

More specifically, the compatibilizing agent (not shown in the drawings) is dispersed in the polyester resin matrix material 101. The compatibilizing agent is configured to assist in improving a compatibility between the toughening agent 102 and the polyester resin matrix material 101.

In terms of material types, the compatibilizing agent is a polyolefin elastomer compatibilizing agent. In particular, the compatibilizing agent is at least one of a polyolefin elastomer grafted with glycidyl methacrylate (POE-g-GMA) and a polyolefin elastomer grafted with maleic anhydride (POE-g-MAH). Preferably, the compatibilizing agent is the polyolefin elastomer grafted with glycidyl methacrylate (POE-g-GMA).

Furthermore, the compatibilizing agent is configured to assist the toughening agent 102 to be dispersed into the polyester resin matrix material 101 with a particle size between 0.5 μm and 1.5 μm, so that the impact-resistant polyester material 100 has an impact-resistant strength of not less than 20 kg-cm/cm. In other words, the compatibilizing agent can effectively improve the compatibility and dispersibility of the toughening agent 102 in the polyester resin matrix material 101, so that the toughening agent 102 can be dispersed into the polyester resin matrix material 101 with a smaller particle size, and is less likely to agglomerate.

In a preferred embodiment of the present disclosure, the toughening agent 102 is dispersed into the polyester resin matrix material 101 with a particle size of between 0.5 μm and 1.2 μm, and the impact-resistant polyester material 100 has the impact-resistant strength between 28 kg-cm/cm and 50 kg-cm/cm, and more preferably between 30 kg-cm/cm and 45 kg-cm/cm.

In terms of content, based on the total weight of the impact-resistant polyester material 100, a content of the compatibilizing agent is preferably between 2 wt % and 15 wt %, and more preferably between 2 wt % and 5 wt %.

According to the above configuration, the compatibilizing agent can effectively assist the toughening agent 102 to be dispersed into the polyester resin matrix material 101 with a smaller particle size. If the content of the compatibilizing agent is lower than the lower limit of the above-mentioned content, the compatibilizing agent cannot properly assist the toughening agent 102 to be dispersed to the polyester resin matrix material 101 with a smaller particle size. Therefore, the auxiliary effect provided by the compatibilizing agent is poor. Conversely, if the content of the compatibilizing agent is higher than the upper limit of the above-mentioned content, the compatibilizing agent may affect the formability of the polyester material.

Furthermore, the content of the toughening agent 102 and the content of the compatibilizing agent have a matching relationship there-between. Specifically, the content of the toughening agent 102 is not less than the content of the compatibilizing agent. Furthermore, a weight ratio range between the toughening agent 102 and the compatibilizing agent is preferably between 1:1 and 4:1, and more preferably between 1:1 and 2:1.

In an embodiment of the present disclosure, a molecular structure of the toughening agent is entirely polyolefin elastomer (POE). A molecular structure of the compatibilizing agent has a main chain and a side chain, and the main chain is a polyolefin elastomer (POE). Therefore, the compatibilizing agent can have excellent compatibility with the toughening agent 102 through the main chain thereof having the same molecular structure as that of the toughening agent.

In an embodiment of the present disclosure, the compatibilizing agent is further defined as a polyolefin elastomer grafted with glycidyl methacrylate (POE-g-GMA). A molecular structure of the compatibilizing agent has a main chain and a side chain melt-grafted with the main chain, the main chain is the polyolefin elastomer (POE), and the side chain is the glycidyl methacrylate (GMA).

The glycidyl methacrylate can produce a ring-opening reaction during a mixing process, and an epoxy group in the glycidyl methacrylate can chemically react with an ester group in a molecular structure of the polyester resin matrix material after the ring-opening reaction, so that the toughening agent 102 is more uniformly dispersed in the polyester resin matrix material 101.

In an embodiment of the present disclosure, in order to improve the dispersibility of the toughening agent 102 (POE) in the polyester resin matrix material 101, the impact-resistant polyester material 100 may be formed into polyester masterbatches by extrusion granulation, so that the toughening agent 102 is dispersed in the polyester material for a first time. The polyester masterbatches are then molded into a molded product such as an injection part or an extruded part by injection molding or extrusion molding, so that the toughening agent 102 is dispersed in the polyester material for a second time.

In an embodiment of the present disclosure, in order to improve the dispersibility and compatibility of the toughening agent 102 (POE) in the polyester resin matrix material 101, a melt flow index of the polyester resin matrix material 101 and a melt flow index of the toughening agent 102 have a matching relationship there-between.

Specifically, the polyester resin matrix material 101 (PET) has a first melt flow index, and the toughening agent 102 (POE) has a second melt flow index. The first melt flow index of the polyester resin matrix material 101 is between 55 g/10 mins. and 65 g/10 mins, and the second melt flow index of the toughening agent 102 is between 75% and 125%, and preferably between 80% and 120% of the first melt flow index of the polyester resin matrix material 101. For example, the first melt flow index of the polyester resin matrix material 101 is substantially 60 g/10 mins, and the second melt flow index of the toughening agent 102 (POE) is substantially 50 g/10 mins.

It should be noted that the term “melt flow index (MI)” referred to herein can also be referred to as a melt flow rate (MFR). The melt flow index refers to a weight of the polymer melt that passes through the standard die (2.095 mm) every ten minutes at a certain temperature and a certain load.

In an embodiment of the present disclosure, the polyester resin matrix material 101 is a continuous phase, and the toughening agent 102 is a dispersed phase dispersed in the continuous phase. The dispersed phase and the continuous phase interact with each other, so that an island structure is formed on a material surface of the impact-resistant polyester material.

It is worth mentioning that the above-mentioned “island structure” refers to a poor compatibility between two high molecular weight polymers (i.e., the polyester resin matrix material 101 and the toughening agent 102). After the two high molecular weight polymers are blended with each other, a heterogeneous system is formed. The dispersed phase is dispersed in the continuous phase, similar to the way that a group of small islands are dispersed in the ocean. By using a mechanism of a two-phase interaction of the sea-island structure, a performance of a polymer can be improved.

### Antibacterial and Antifungal Polyester Material

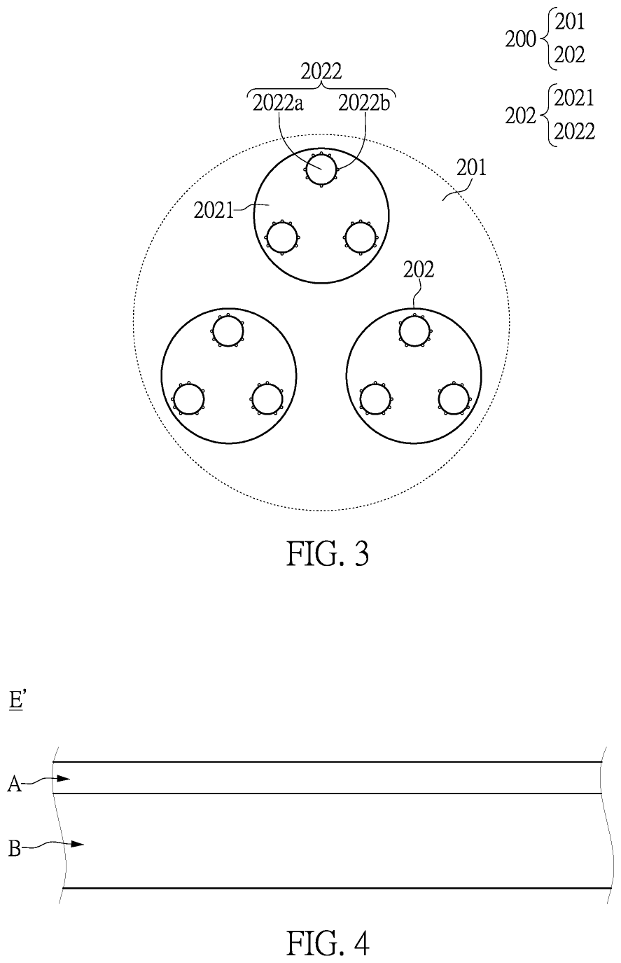

Referring to FIG. 3, in each of the antibacterial and antifungal functional layers A, the antibacterial and antifungal polyester material 200 has good antibacterial and antifungal capabilities. The antibacterial and antifungal polyester material 200 can still maintain a certain antibacterial and antifungal effect after being used for a period of time. In addition, the antibacterial and antifungal capabilities of the antibacterial and antifungal polyester material 200 can correspond to more types of bacteria and fungus.

To achieve the above purpose, the antibacterial and antifungal polyester material 200 of the present embodiment includes a polyester resin substrate material 201 and a plurality of functional polyester masterbatches 202. The plurality of functional polyester masterbatches 202 are dispersed in the polyester resin substrate material 201 by means of melt extrusion molding. The antibacterial and antifungal polyester material 200 of the present embodiment can have the capabilities of antibacterial and antifungal by introducing the functional polyester masterbatches 202 therein.

More specifically, each of the functional polyester masterbatches 202 includes: a polyester resin matrix 2021 and an antibacterial and antifungal additive 2022. The antibacterial and antifungal additive 2022 includes a plurality of glass beads 2022a, the plurality of glass beads 2022a are dispersed in the polyester resin matrix 2021, and a plurality of silver nanoparticles 2022b are distributed on an outer surface of each of the glass beads 2022a. Therefore, the antibacterial and antifungal polyester material 200 of the present embodiment can have antibacterial and antifungal capabilities through the introduction of the functional polyester masterbatches 202.

In more detail, since the plurality of silver nanoparticles 2022b are dispersed on the outer surface of each of the glass beads 2022a, the plurality of silver nanoparticles 2022b do not agglomerate with each other, and the plurality of silver nanoparticles 2022b can be dispersed on the outer surface of each of the glass beads 2022a in a nanometer-scale size, thereby providing the antibacterial and antifungal capabilities.

It is worth mentioning that the glass beads 2022a and the plurality of silver nanoparticles 2022b distributed on the outer surface thereof are dispersed in the polyester resin substrate material 201 through the functional polyester masterbatches 202. Therefore, the antibacterial and antifungal polyester material 200 includes the plurality of silver nanoparticles 2022 dispersed in nanometer-scale sizes, so that the antibacterial and antifungal polyester material 200 has antibacterial and antifungal capabilities.

In terms of content, based on a total weight of the antibacterial and antifungal polyester material being 100 wt %, a content of the polyester resin substrate material 201 is preferably between 80 wt % and 98 wt %, and more preferably between 90 wt % and 98 wt %. Furthermore, a content of the plurality of functional polyester masterbatches 202 is preferably between 2 wt % and 20 wt %, and more preferably between 2 wt % and 10 wt %.

Furthermore, in each of the functional polyester masterbatches 202, a weight ratio of the polyester resin matrix 2021 relative to the antibacterial and antifungal additive 2022 (including the glass beads 2022a and the silver nanoparticles 2022b) preferably ranges from 70 to 99:1 to 30, and more preferably ranges from 85 to 95:5 to 15. Overall, a content of the plurality of silver nanoparticles 2022b in the antibacterial and antifungal polyester material 200 is preferably between 0.1 wt % and 5.0 wt %, and more preferably between 0.2 wt. % and 2.0 wt %.

According to the above configuration, the antibacterial and antifungal additive 2022 in the functional polyester masterbatches 202 can provide sufficient antibacterial and antifungal effects in the polyester material. If the content of the antibacterial and antifungal additive 2022 is lower than the lower limit of the above-mentioned content, the concentration of the silver nanoparticles 2022b may be insufficient, thereby failing to provide sufficient antibacterial and antifungal effects. Conversely, if the content of the antibacterial and antifungal additive 2022 is higher than the upper limit of the above-mentioned content, the concentration of the glass beads 2022a may be too high to be uniformly dispersed in the polyester resin substrate material 201, and excessive glass beads 2022a may affect a molding effect of the polyester material.

In an embodiment of the present disclosure, in each of the glass beads 2022a, the plurality of silver nanoparticles 2022b are distributed on the outer surface of the glass beads 2022a through physical adsorption, but the present disclosure is not limited thereto.

It is worth mentioning that, since the silver nanoparticles 2022b use the glass beads 2022a as a carrier thereof and are dispersed on the outer surface of the glass beads 2022a in nanometer-scale sizes, the silver nanoparticles 2022b do not easily agglomerate. In addition, when the functional polyester masterbatches 202 are dispersed in the polyester resin substrate material 201 by means of melt extrusion molding, the glass beads 2022a may be broken. However, most of the silver nanoparticles 2022b will still be dispersed and adsorbed on the outer surface of the glass beads 2022a in nanometer-scale sizes, and the silver nanoparticles 2022b will not agglomerate, so that the silver nanoparticles 2022b can still provide sufficient antibacterial and antifungal capabilities.

In an embodiment of the present disclosure, in the antibacterial and antifungal polyester material 200, at least part of the plurality of glass beads 2022a are distributed on a surface portion of the polyester material 100, so that at least part of the plurality of silver nanoparticles 2022b are exposed to an external environment, and the polyester material 100 can have of antibacterial and antifungal capabilities.

In an embodiment of the present disclosure, the antibacterial and antifungal polyester material 200 can be extended to form an extended polyester material. It is worth mentioning that, after the antibacterial and antifungal polyester material 200 is extended, the glass beads 2022a distributed on the surface portion of the polyester material 100 can protrude more from the surface portion of the polyester material 100, as shown in FIG. 3. Accordingly, a quantity of the silver nanoparticles 2022b exposed to the external environment can be increased, so that the capabilities of antibacterial and antifungal of the polyester material 200 can be more significant.

In terms of material selection, the polyester resin substrate material 201 is the matrix material of the antibacterial and antifungal polyester material 200, and the polyester resin substrate material 201 is obtained by a condensation polymerization reaction of dibasic acid and diol or its derivatives. Furthermore, the polyester resin matrix 2021 in the functional polyester masterbatches 202 is also obtained by the condensation polymerization reaction of dibasic acid and diol or its derivatives.

It is worth mentioning that, as shown in FIG. 3, the material of the polyester resin substrate material 201 is substantially the same as that of the polyester resin matrix 2021, so that the polyester resin substrate material 201 and the polyester resin matrix 2021 have good compatibility without significant boundaries.

In an embodiment of the present disclosure, to maintain a high transparency and a low haze of the antibacterial and antifungal polyester material 200, the refractive indexes of different materials have a matching relationship there-between.

For example, the polyester resin substrate material 201 has a first refractive index, the polyester resin matrix 2021 has a second refractive index, and each of the glass beads 2022a has a third refractive index. The first refractive index is preferably between 1.55 and 1.60, and more preferably between 1.57 and 1.59. Furthermore, the second refractive index is preferably between 95% and 105% of the first refractive index, and the third refractive index is preferably between 95% and 105% of the first refractive index.

According to the above-mentioned matching relationship of the refractive indexes of different materials, the antibacterial and antifungal polyester material 200 can have high transparency and low haze.

For example, the antibacterial and antifungal polyester material 200 preferably has a visible light transmittance of not less than 80%, and more preferably not less than 90%. The antibacterial and antifungal polyester material 200 preferably has a haze of not greater than 5%, and more preferably not greater than 3%.

In an embodiment of the present disclosure, the polyester resin matrix 2021 in each of the functional polyester masterbatches 202 is polyethylene terephthalate (PET) with low crystallinity, and the crystallinity of the polyester resin matrix 2021 is between 5% and 15%.

It is worth mentioning that, in a conventional art, an antibacterial and antifungal treatment on a surface of a material by a coating method or a spray method may enable the material to have excellent transparency. However, such products have poor durability and only work against limited types of bacteria. Furthermore, most of master-batch carriers of an internal addition process are polypropylene (PP) and polybutylene terephthalate (PBT), which have poor compatibility with polyester materials (i.e., PET), such that the product has poor transparency and extensibility.

Compared with the conventional art, the antibacterial and antifungal polyester material 200 of the embodiment of the present disclosure uses the polyethylene terephthalate (PET) with low crystallinity as the master-batch carrier. The functional polyester masterbatches 202 can be processed by a twin-screw extruder to disperse the glass beads 2022a that has adsorbed the silver nanoparticles 2022b and to introduce PET polyester material (i.e., the polyester resin substrate material 201) during material processing. Therefore, the antibacterial and antifungal polyester material 200 simultaneously maintains excellent antibacterial and antifungal capabilities, visible light transmittance, and extensibility.

In an embodiment of the present disclosure, specifications of the glass beads 2022a have a preferred range. For example, in each of the glass beads 2022a, a matrix material of the glass bead 2022a can be soluble glass powders, and a particle size of the glass bead 2022a is not greater than 10 μm, and preferably between 3 μm and 10 μm. A density of the glass bead 2022a is between 2 g/cm³ and 3 g/cm³, and preferably between 2.3 g/cm³ and 2.8 g/cm³, and a heat-resistant temperature of the glass bead 2022a is not less than 500° C.

According to the above configuration, the glass beads 2022a can adsorb a sufficient amount of silver nanoparticles 2022b to be dispersed into the polyester resin matrix 2021. The glass beads 2022a can withstand a high temperature and a high pressure of a twin-screw extrusion process, while still adsorbing the sufficient amount of silver nanoparticles 2022b, so that the antibacterial and antifungal polyester material 200 has antibacterial and antifungal capabilities.

In terms of antibacterial and antifungal capabilities, the antibacterial and antifungal additive has an antibacterial capability against following types of bacteria, including: Escherichia coli, Staphylococcus aureus, Pneumoniae bacillus, Salmonella, Pseudomonas aeruginosa, and drug-resistant Staphylococcus aureus.

In addition, the antibacterial and antifungal additive has an antifungal capability against following types of fungus, including: Aspergillus niger, Penicillium tetrapine, Chaetomium globosum, Gliocladium virens, and Aureobasidium pullulans.

In terms of antibacterial detection, the antibacterial and antifungal polyester material 200 passes a test performed by SGS S.A. against the six types of bacteria including: Escherichia coli, Staphylococcus aureus, Pneumoniae bacillus, Salmonella, Pseudomonas aeruginosa, and drug-resistant Staphylococcus aureus. The antibacterial activity values R to the six types of bacteria are all greater than 2, which indicate an excellent antibacterial effect. In terms of antifungal detection, the antibacterial and antifungal polyester material 200 passes a test performed by SGS S.A. against the five types of fungi, including Aspergillus niger, Penicillium tetrapine, Chaetomium globosum, Gliocladium virens, and Aureobasidium pullulans. The grades for the five types of fungal are all 0 grade (i.e., with no fungal growth), which indicate an excellent antifungal effect.

It is worth mentioning that, in an embodiment of the present disclosure not illustrated in the drawings, the antibacterial and antifungal additive is directly dispersed in the polyester resin substrate material. In other words, the antibacterial and antifungal additive is not dispersed in the polyester resin substrate material through the functional polyester masterbatches, and the antibacterial and antifungal additive is directly dispersed in the polyester resin substrate material.

More specifically, the antibacterial and antifungal polyester material of the present embodiment includes a polyester resin substrate material and an antibacterial and antifungal additive. The antibacterial and antifungal additive includes a plurality of glass beads, the plurality of glass beads are dispersed in the polyester resin substrate material, and a plurality of silver nanoparticles are distributed on an outer surface of each of the glass beads to enable the polyester material to have capabilities of antibacterial and antifungal.

### Second Embodiment

Referring to FIG. 4, a second embodiment of the present disclosure also provides an antibacterial and antifungal polyester laminated structure E′. The antibacterial and antifungal polyester laminated structure E′ of the present embodiment is substantially the same as the above-mentioned first embodiment. The difference is that the antibacterial and antifungal polyester laminated structure E′ of the present embodiment is a double laminated structure instead of a sandwich structure.

Specifically, the antibacterial and antifungal polyester laminated structure E′ of the present embodiment includes a main structure support layer B and an antibacterial and antifungal functional layer A. The main structure support layer B has two side surfaces opposite to each other. The antibacterial and antifungal functional layer A is formed on one of the two side surfaces of the main structure support layer B.

The main structure support layer B is formed of an impact-resistant polyester material, and the main structure support layer B enables an entirety of the polyester laminated structure E′ to have an impact-resistant strength of not less than 20 kg-cm/cm.

The antibacterial and antifungal functional layer A is formed of an antibacterial and antifungal polyester material, the antibacterial and antifungal polyester material includes an antibacterial and antifungal additive, and the antibacterial and antifungal additive includes a plurality of glass beads. The plurality of glass beads are dispersed in the antibacterial and antifungal functional layer, a plurality of silver nanoparticles are distributed on an outer surface of each of the glass beads, and the antibacterial and antifungal additive enables the antibacterial and antifungal functional layer A to have antibacterial and antifungal capabilities.

### Beneficial Effects of the Embodiments

In conclusion, the antibacterial and antifungal polyester laminated structure of the present disclosure can be applied to products with requirements for antibacterial, antifungal and impact resistance capabilities, such as luggage cases, food trays, and freezer trays, and so on, by virtue of “the surface layer of the polyester laminated structure being an antibacterial and antifungal functional layer with antibacterial and antifungal capabilities, and the inner layer of the polyester laminated structure being a main structure support layer with supporting ability” and “the main structure support layer being formed of an impact-resistant polyester material, and the main structure support layer enabling an entirety of the polyester laminated structure to have an impact-resistant strength of not less than 20 kg-cm/cm” and “each of the antibacterial and antifungal functional layers being formed of an antibacterial and antifungal polyester material, and the antibacterial and antifungal polyester material enabling the surface layer of the polyester laminated structure to have antibacterial and antifungal capabilities”.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antibacterial and antifungal polyester laminated structure, comprising:
a main structure support layer having two side surfaces opposite to each other; wherein the main structure support layer is formed of an impact-resistant polyester material, and the main structure support layer enables the polyester laminated structure to have an impact-resistant strength of greater than or equal to 20 kg-cm/cm; and
two antibacterial and antifungal functional layers being respectively formed on the two side surfaces of the main structure support layer; wherein each of the antibacterial and antifungal functional layers is formed of an antibacterial and antifungal polyester material, the antibacterial and antifungal polyester material includes an antibacterial and antifungal additive, the antibacterial and antifungal additive includes a plurality of glass beads, the plurality of glass beads being dispersed in the antibacterial and antifungal functional layers, and wherein a plurality of silver nanoparticles are distributed on an outer surface of each of the glass beads, and the antibacterial and antifungal additive enables the antibacterial and antifungal functional layers to have antibacterial and antifungal capabilities.

2. The antibacterial and antifungal polyester laminated structure according to claim 1, wherein the main structure support layer and the two antibacterial and antifungal functional layers are formed into an antibacterial and antifungal polyester sheet material having a sandwich structure by co-extrusion; wherein a thickness of the main structure support layer is greater than a thickness of each of the antibacterial and antifungal functional layers, the thickness of the main structure support layer is between 80 μm and 4,000 μm, and the thickness of each of the antibacterial and antifungal functional layers is between 10 μm and 200 μm.

3. The antibacterial and antifungal polyester laminated structure according to claim 1, wherein, in the main structure support layer, the impact-resistant polyester material includes:
a polyester resin matrix material;
a toughening agent dispersed in the polyester resin matrix material;
wherein the toughening agent is a polyolefin elastomer (POE); and
a compatibilizing agent dispersed in the polyester resin matrix material;
wherein the compatibilizing agent is configured to assist in increasing a compatibility between the toughening agent and the polyester resin matrix material;
wherein the compatibilizing agent is configured to assist in dispersion of the toughening agent having a particle size between 0.5 μm and 1.5 μm into the polyester resin matrix material, so that the impact-resistant polyester material has the impact-resistant strength of not less than 20 kg-cm/cm.

4. The antibacterial and antifungal polyester laminated structure according to claim 3, wherein, in the main structure support layer, the compatibilizing agent is at least one of a polyolefin elastomer grafted with glycidyl methacrylate (POE-g-GMA) and a polyolefin elastomer grafted with maleic anhydride (POE-g-MAH).

5. The antibacterial and antifungal polyester laminated structure according to claim 3, wherein, based on a total weight of the impact-resistant polyester material being 100 wt %, a content of the polyester resin matrix material is between 70 wt % and 95 wt %, a content of the toughening agent is between 5 wt % and 15 wt %, and a content of the compatibilizing agent is between 2 wt % and 15 wt %; wherein the content of the toughening agent is not less than the content of the compatibilizing agent, and a weight ratio of the toughening agent relative to the compatibilizing agent ranges from 1:1 to 4:1.

6. The antibacterial and antifungal polyester laminated structure according to claim 3, wherein a molecular structure of the toughening agent is entirely polyolefin elastomer, the compatibilizing agent is a polyolefin elastomer grafted with glycidyl methacrylate (POE-g-GMA), a molecular structure of the compatibilizing agent has a main chain and a side chain melt-grafted with the main chain, the main chain is the polyolefin elastomer, and the side chain is the glycidyl methacrylate (GMA); wherein the glycidyl methacrylate carries out a ring-opening reaction during a mixing process, and an epoxy group in the glycidyl methacrylate chemically reacts with an ester group in a molecular structure of the polyester resin matrix material after the ring-opening reaction.

7. The antibacterial and antifungal polyester laminated structure according to claim 1, wherein, in each of the antibacterial and antifungal functional layers, the antibacterial and antifungal polyester material further includes:
a polyester resin substrate material; and
a plurality of functional polyester masterbatches;
wherein the plurality of functional polyester masterbatches are dispersed in the polyester resin substrate material by melt extrusion molding;
wherein each of the functional polyester masterbatches includes a polyester resin matrix and the antibacterial and antifungal additive, and the plurality of glass beads of the antibacterial and antifungal additive are dispersed in the polyester resin matrix.

8. The antibacterial and antifungal polyester laminated structure according to claim 7, wherein, based on a total weight of the antibacterial and antifungal polyester material being 100 wt %, a content of the polyester resin substrate material is between 80 wt % and 98 wt %, and a content of the plurality of functional polyester masterbatches is between 2 wt % and 20 wt %; wherein, in each of the functional polyester masterbatches, a weight ratio of the polyester resin matrix relative to the antibacterial and antifungal additive ranges from 70 to 99: 1 to 30.

9. The antibacterial and antifungal polyester laminated structure according to claim 7, wherein the antibacterial and antifungal polyester laminated structure is formed into an extended polyester material through an extension process; wherein, in each of the antibacterial and antifungal functional layers, at least part of the plurality of glass beads are distributed on a surface portion of the antibacterial and antifungal functional layer, so that at least part of the plurality of silver nanoparticles are exposed to an outside environment, and the antibacterial and antifungal functional layer have antibacterial and antifungal capabilities.

10. The antibacterial and antifungal polyester laminated structure according to claim 7, wherein the polyester resin substrate material is polyethylene terephthalate, and in each of the functional polyester masterbatches, the polyester resin matrix is polyethylene terephthalate; wherein the polyester resin substrate material has a first refractive index, the polyester resin matrix has a second refractive index, and each of the glass beads has a third refractive index; wherein the first refractive index is between 1.55 and 1.60, the second refractive index is between 95% and 105% of the first refractive index, and the third refractive index is between 95% and 105% of the first refractive index.

11. The antibacterial and antifungal polyester laminated structure according to claim 7, wherein, in each of the glass beads, a matrix material of the glass bead is soluble glass powder, a particle size of the glass bead is not greater than 10 μm, a density of the glass bead is between 2 g/cm³ and 3 g/cm³, and a heat-resistant temperature of the glass beads is not less than 500° C.

12. The antibacterial and antifungal polyester laminated structure according to claim 7, wherein the antibacterial and antifungal additive has an antibacterial capability against following types of bacteria, including: Escherichia coli, Staphylococcus aureus, Bacillus pneumoniae, Salmonella, Pseudomonas aeruginosa, and drug-resistant Staphylococcus aureus; wherein the antibacterial and antifungal additive has an antifungal capability against following types of fungi, including: Aspergillus niger, Penicillium tetrapine, Chaetomium globosum, Gliocladium virens, and Aureobasidium pullulans.

13. The antibacterial and antifungal polyester laminated structure according to claim 1, wherein a matrix material of the main structure support layer is polyethylene terephthalate, and a matrix material of each of the antibacterial and antifungal functional layers is polyethylene terephthalate.

14. An antibacterial and antifungal polyester laminated structure, comprising:
a main structure support layer having two side surfaces opposite to each other; wherein the main structure support layer is formed of an impact-resistant polyester material, and the main structure support layer enables the polyester laminated structure to have an impact-resistant strength of not less than 20 kg-cm/cm; and
an antibacterial and antifungal functional layer being formed on one of the two side surfaces of the main structure support layer;
wherein the antibacterial and antifungal functional layer is formed of an antibacterial and antifungal polyester material, the antibacterial and antifungal polyester material includes an antibacterial and antifungal additive, the antibacterial and antifungal additive includes a plurality of glass beads, the plurality of glass beads are dispersed in the antibacterial and antifungal functional layer, a plurality of silver nanoparticles are distributed on an outer surface of each of the glass beads, and the antibacterial and antifungal additive enables the antibacterial and antifungal functional layer to have antibacterial and antifungal capabilities.
